(19) United States
(12) Patent Application Publication
(10) Pub. No.: US 2016/0328740 A1
(43) Pub. Date: Nov. 10, 2016

(54) TRACKING RENDERED OFFLINE ADVERTISEMENT

(71) Applicant: International Business Machines Corporation, Armonk, NY (US)

(72) Inventors: Yuk L. Chan, Rochester, NY (US); Michael D. Essenmacher, Danbury, CT (US); James M. Hertzig, Tillson, NY (US); David B. Lection, Raleigh, NC (US); Mark A. Scott, (US)

(21) Appl. No.: 14/706,468

(22) Filed: May 7, 2015

(51) Int. Cl. G06Q 30/02

(52) U.S. Cl. CPC G06Q 30/0246

(57) ABSTRACT

In an approach to tracking an offline advertisement, a computer downloads one or more advertisements from one or more advertisement providers to a first online computing device. The computer determines whether a local communication connection exists between the first online computing device and at least one offline computing device. In response to determining that the local communication connection exists between the first online computing device and an offline computing device, the computer selects, based on attributes of the offline computing device, one or more advertisements to download from the first online computing device to the offline computing device. The computer downloads one or more selected advertisements to the offline computing device. The computer determines whether advertisement tracking data exists on the offline computing device. In response to determining advertisement tracking data exists on the offline computing device, the computer retrieves advertisement tracking data from the offline computing device.

### BACKGROUND OF THE INVENTION

The present invention relates generally to the field of advertisement communication, and more particularly to tracking a rendered offline advertisement.

Online advertising may be an effective method for advertisers to reach consumers. Online advertising may give advertisers the ability to directly measure the effectiveness of their advertisements, by measuring the web traffic generated by the advertisements and/or by measuring ecommerce transactions generated by the advertisements. While online advertising campaigns may continue to grow in popularity, offline advertising campaigns, such as print advertisements, radio advertisements, and television advertisements may still be a preferred form of advertising for some advertisers. It may be difficult, however, to directly measure the effectiveness of an offline advertising campaign, particularly the effectiveness of the campaign on ecommerce. In addition, many consumers of various types of media content often ignore many advertisements because the consumers are not interested in those advertisements. Also, advertisements that are of interest to a consumer may not be viewed by the consumer since the consumer may be unavailable when the advertisements are presented. For an advertiser, the choice between online and offline advertising is a balance between effectiveness, cost, and profit margin. In addition, there are many devices that either do not have a direct connection to the Internet or have only a temporary connection to the Internet, therefore the devices may not have the capability to receive real-time advertisements. These offline devices may provide alternative advertisement channels to an advertiser.

For online advertisers, affordability and effectiveness of a keyword search ad presented to a user by an advertisement provider depends on what is known as a conversion rate, i.e., the percentage of users that visit an advertiser's website and make a purchase. For example, if one out of ten website visitors make a purchase, then the conversion rate is ten percent. The number of users that click on the ad over a period of time, whether or not the users make a purchase, is known as the click-through-rate (CTR). In order to make a profit, the advertiser must have a profit margin that covers the expense of the advertisement for the users that visit the site without making a purchase. For example, if an advertisement broker charges one dollar to provide a keyword search ad, the CTR is fifty percent, and the conversion rate is ten percent, then the average purchase per user must generate twenty dollars of profit to cover the advertisement cost.

### SUMMARY

Embodiments of the present invention disclose a method, a computer program product, and a system for tracking an offline advertisement. The method may include a computer downloading one or more advertisements from one or more advertisement providers to a first online computing device. The computer determines whether a local communication connection exists between the first online computing device and at least one offline computing device. In response to determining that the local communication connection exists between the first online computing device and at least one offline computing device, the computer selects, based, at least in part, on one or more attributes of the at least one offline computing device, one or more advertisements to download from the first online computing device to the at least one offline computing device. The computer downloads one or more selected advertisements to the at least one offline computing device. The computer determines whether advertisement tracking data exists on the at least one offline computing device. In response to determining advertisement tracking data exists on the at least one offline computing device, the computer retrieves advertisement tracking data from the at least one offline computing device.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a server-side of an ads offload engine, on a server computer within the distributed data processing environment of FIG. 1, for downloading advertisements and receiving tracking data, in accordance with an embodiment of the present invention;

FIG. 3 is a flowchart depicting operational steps of a client-side of an ads offload engine, on an offline client device within the distributed data processing environment of FIG. 1, for rendering and tracking advertisements on an offline computing device, in accordance with an embodiment of the present invention; and

FIG. 4 depicts a block diagram of components of the server computer or the offline client device executing the ads offload engine within the distributed data processing environment of FIG. 1, in accordance with an embodiment of the present invention.

### DETAILED DESCRIPTION

Users of online computing devices, such as mobile phones, laptops, and tablets, are often presented with numerous advertisements (“ads”) while viewing or searching content online. Many users may be annoyed by the ads, especially if the ads are for a product or service the user is not interested in. In addition, users may just ignore online ads because the users have become accustomed to the display and are no longer distracted by the ads. In these examples, online advertisement is less effective and does not produce the advertisers' desired click-through-rate (CTR). Embodiments of the present invention recognize that advertising effectiveness may be improved by providing a user an option to receive advertisements on an offline device in order to receive incentives. For example, an incentive may be to reduce or replace advertisements received on an online device. In another example, an incentive may be to receive a free product, such as a wearable blood pressure monitor. By providing an incentive to view or listen to ads offline, advertisers may gain an increase in a user's interest in the ads. Implementation of embodiments of the invention may take a variety of forms, and exemplary implementation details are discussed subsequently with reference to the Figures.

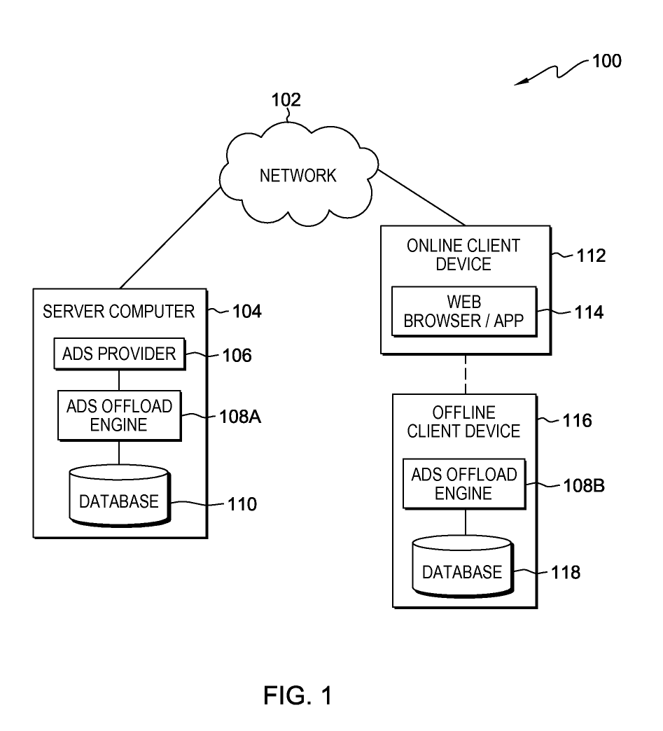

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104, online client device 112, and offline client device 116, where server computer 104 and online client device 112 are interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 104, online client device 112, and other computing devices (not shown) within distributed data processing environment 100.

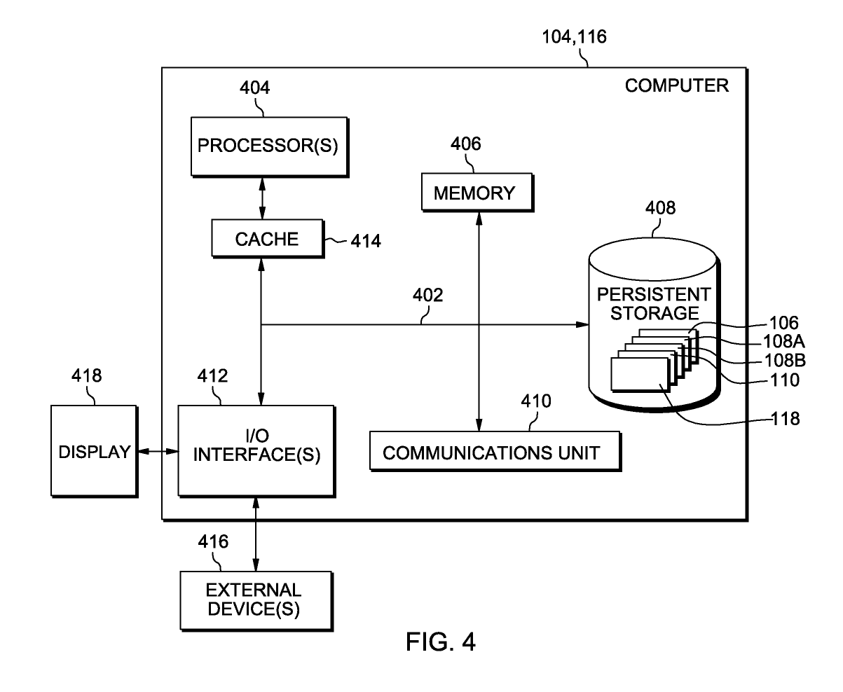

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with online client device 112 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes ads provider 106, ads offload engine 108A, and database 110. Server computer 104 may include internal and external hardware components, as depicted and described in further detail with respect to FIG. 4.

In the depicted environment, ads provider 106 resides on server computer 104. In another embodiment, ads provider 106 may reside elsewhere in the environment, provided that ads provider 106 is capable of communicating with ads offload engine 108A via a network, such as network 102. Ads provider 106 is a third party entity that provides or brokers ads from an advertiser to a user of online client device 112. Examples of ads providers include search engines, such as Google and Yahoo! ®, as well as general content providers, such as CNN®. When a user views content that involves ads provider 106, ads provider 106 may display ads generally related to the displayed content or a topic the user has expressed interest in, based on user viewing history. Ads provider 106 may charge an advertiser to display the advertiser's ad, and charges may depend on the ad's conversion rate or click-through-rate.

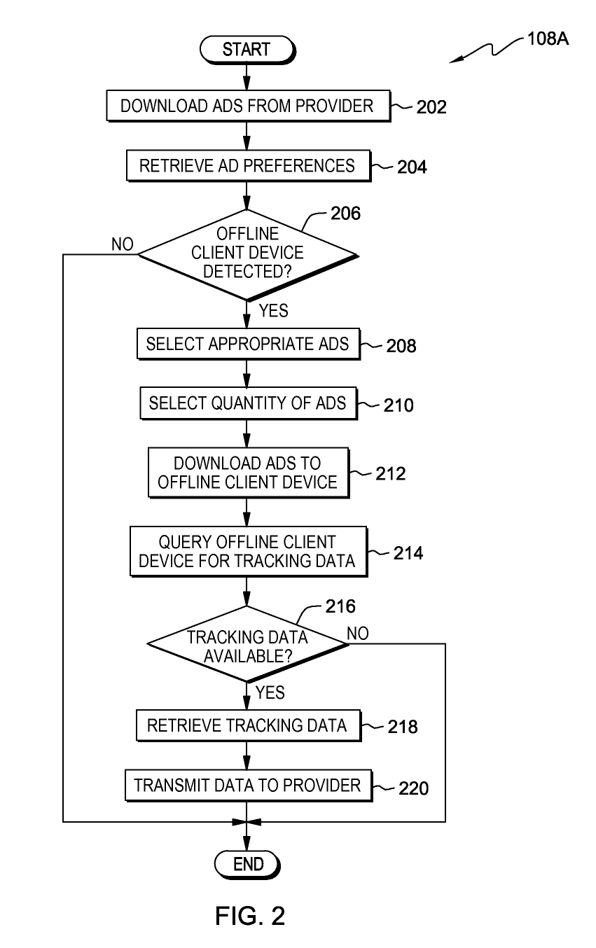

Ads offload engine 108A is the server side of a computer program for offloading ads received on an online device, such as online client device 112, to an offline device, such as offline client device 116, in order to receive incentives. Ads offload engine 108A downloads ads and ad preferences from ads provider 106. When ads offload engine 108A detects a local communication connection exists between server computer 104 and offline client device 116, ads offload engine 108A downloads the ads and ad preferences to database 118 of offline client device 116. In one embodiment, the local communication connection between server computer 104 and offline client device 116 is made indirectly, via a connection of each device to online client device 112. In another embodiment, the local communication connection between server computer 104 and offline client device 116 is made directly between the two devices. Ads offload engine 108A also retrieves the ad tracking data from offline client device 116 and provides the tracking data to ads provider 106. Ads offload engine 108A is depicted and described in further detail with respect to FIG. 2.

Database 110 resides on server computer 104. In another embodiment, database 110 can reside on online client device 112 or elsewhere in the environment. A database is an organized collection of data. Database 110 can be implemented with any type of storage device capable of storing data and configuration files that can be accessed and utilized by server computer 104, such as a database server, a hard disk drive, or a flash memory. In other embodiments, database 110 can represent multiple storage devices within offline client device 116. Database 110 stores ads and ad preferences from ads provider 106. Database 110 also stores ad tracking data retrieved from offline client device 116.

Online client device 112 can be a desktop computer, a laptop computer, a tablet computer, a specialized computer server, a smart phone, or any programmable electronic device capable of communicating with various components and devices within distributed data processing environment 100, via network 102. In general, online client device 112 represents any programmable electronic device or combination of programmable electronic devices capable of executing machine readable program instructions and communicating with other computing devices (not shown) within distributed data processing environment 100 via a network, such as network 102. Online client device 112 also includes the capability of communicating with offline client device 116 via a temporary wired communication connection, such as a USB cord, or wirelessly, via Bluetooth® or Wi-Fi. Online client device 112 includes web browser/app 114. Online client device 112 may also include memory (not shown) capable of storing device preferences for receiving online ads.

Web browser/app 114 represents a software application used to view, interact with, or search for content, via network 102, with which an advertiser, or ads provider, may present online ads to a user. A web browser is a software application for retrieving, presenting, and traversing information resources on the World Wide Web. Although web browsers are primarily intended to use the World Wide Web, they can also be used to access information provided by web servers in private networks, including intranets, or files in file systems. A web browser may use a web user interface (WUI) to display text, documents, web browser windows, user options, application interfaces, and instructions for operation. Mobile application software, or an “app,” is a computer program designed to run on smart phones, tablet computers and other mobile devices.

Offline client device 116 can be any programmable electronic device capable of communicating with various components and devices, such as online client device 112, via wired or wireless communication technology, such as a USB cord, Bluetooth®, or Wi-Fi. In the depicted environment, the dotted line between online client device 112 and offline client device 116 represents a temporary local communication connection between the two devices. Offline client device 116 may be one of a plurality of offline computing devices such as a podcast player, an electronic picture frame, a Global Positioning System (GPS) device, a smart watch or other wearable device, a USB thumb drive with display capability, or any offline computing device capable of at least temporarily communicating with an online device, such as online client device 112, and presenting, or rendering, video and/or audio advertisements to a user. In the depicted embodiment, offline client device 116 temporarily communicates with server computer 104 through online client device 112, via network 102. In another embodiment, offline client device 116 may temporarily communicate directly with server computer 104, via network 102. Offline client device 116 may include internal and external hardware components, as depicted and described in further detail with respect to FIG. 4.

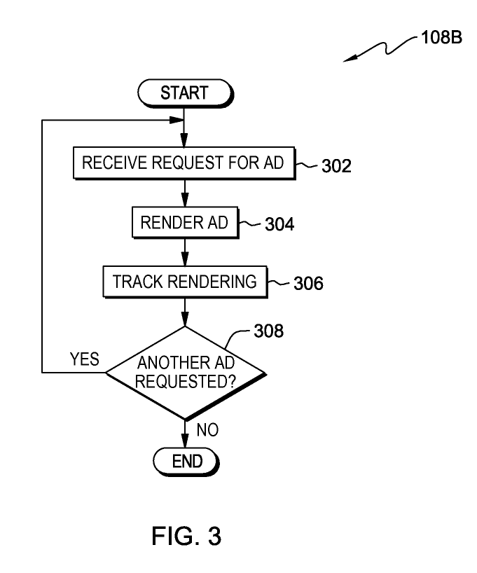

Ads offload engine 108B is the client side of a computer program for offloading ads received on an online device, such as online client device 112, to an offline device, such as offline client device 116, in order to receive incentives. While offline client device 116 is temporarily connected to online client device 112, ads offload engine 108B downloads and stores ads for rendering on offline client device 116 in the future. When a user requests to receive an ad on offline client device 116, ads offload engine 108B renders, or presents, the ad and tracks the rendering. Once one or more ads have been rendered, and offline client device 116 is again temporarily connected to online client device 112, ads offload engine 108B uploads ad tracking data, via online client device 112, to server computer 104. Viewing ads received on offline client device 116, via ads offload engine 108B, may provide the user with credits, or points, for use toward incentives on online client device 112 or elsewhere. Ads offload engine 108B is depicted and described in further detail with respect to FIG. 3.

Database 118 resides on offline client device 116. Database 118 can be implemented with any type of storage device capable of storing data and configuration files that can be accessed and utilized by online client device 112, such as a database server, a hard disk drive, or a flash memory. In other embodiments, database 118 can represent multiple storage devices within offline client device 116. Database 118 stores ads downloaded by ads offload engine 108B to offline client device 116. In addition to the downloaded ads, database 118 stores advertisement preferences specified by the advertiser. Database 118 also stores ad tracking data accumulated when the user receives an ad by video display, audio play, any additional formats, or any combination of formats.

In one embodiment, when a user of online client device 112 wants to utilize ads offload engine 108A for an incentive of reducing the frequency of online ad displays, the user registers devices with ads offload engine 108A. The user registers one or more online devices, such as online client device 112, that display online ads for which the user wishes to reduce the frequency or change the type of online ad displays. The user also registers one or more offline devices, such as offline client device 116, onto which the user wishes to offload ads. The user identifies the devices and the corresponding device attributes for each device. Device attributes may include, but are not limited to, display capability and resolution for still pictures or video, audio capability and resolution, etc. In one embodiment, ads offload engine 108B detects device attributes automatically when a particular device is connected, via network 102, to server computer 104. In another embodiment, the user provides device attributes. In addition to registering devices, the user may provide offline device preferences, for example, how frequently the user prefers ads to be rendered or the maximum number of ads to store. The user may also provide online device preferences, for example, a percentage of ad credits to be applied to each registered online device.

FIG. 2 is a flowchart depicting operational steps of the server side of ads offload engine 108A, on server computer 104 within distributed data processing environment 100 of FIG. 1, for downloading advertisements and receiving tracking data, in accordance with an embodiment of the present invention.

Ads offload engine 108A downloads ads from provider (step 202). Ads offload engine 108A downloads one or more ads from one or more ads providers, such as ads provider 106. Ads offload engine 108A stores the downloaded ads in database 110. Ads may be still images, video, audio, or a combination of two or more of the three.

Ads offload engine 108A retrieves ad preferences (step 204). Ads offload engine 108A retrieves ad preferences that correspond to the previously downloaded ads. In one embodiment, ad preferences are included in the metadata of the downloaded ads. In another embodiment, ads provider 106 provides the preferences separately from the downloaded ads. Ad preferences are information regarding how the advertiser prefers the ads to be integrated with device content. For example, an advertiser with a limited budget may specify that an ad repeat for a maximum of ten times. In another example, Texas diner ads play on a GPS enabled device when the GPS indicates the device is located in Texas. In a further example, classical music concert ticket ads play when the device plays a podcast with a title related to classical music or art.

Ads offload engine 108A determines whether an offline client device is detected (decision block 206). In one embodiment, ads offload engine 108A determines that an offline client device, such as offline client device 116, is connected through network 102 to server computer 104 via a connection to an online client device, such as online client device 112. In one embodiment, online client device 112 provides an indication to ads offload engine 108A that offline client device 116 is connected such that ads offload engine 108A detects offline client device 116. In another embodiment, offline client device 116 may be directly connected to server computer 104 via wired or wireless technology. Ads offload engine 108A may determine that more than one offline client devices is detected. If ads offload engine 108A determines that an offline client device is not detected (“no” branch, decision block 206), then ads offload engine 108A completes execution and ends.

If ads offload engine 108A determines an offline client device is detected (“yes” branch, decision block 206), then ads offload engine 108A selects appropriate ads (step 208). Ads offload engine 108A determines which one or more ads are appropriate to download to the particular one or more detected offline client devices based on the format of the ads and the device attributes. For example, video ads are not appropriate for a podcast player with only audio capability. In one embodiment, ads offload engine 108A can convert the format of an ad to a format compatible with, i.e., matching the capability and attributes of the offline client device. For example, ads offload engine 108A can convert a video ad to an audio ad such that the ad can be inserted into a podcast.

Ads offload engine 108A selects a quantity of ads (step 210). Ads offload engine 108A determines the number of ads to download to the particular one or more detected offline client devices based on previously registered offline device preferences, such as the maximum number of ads to store as well as the frequency with which the ads are rendered. In one embodiment, ads offload engine 108A may also estimate the quantity of ads to download based on historical and dynamic criteria. For example, ads offload engine 108A may take into account an estimate of the time the offline client device will be in use, the amount of time passed since a previous download, the number of times one or more ads may be repeated, etc.

Responsive to selecting one or more appropriate types and quantities of ads, ads offload engine 108A downloads ads to offline client device (step 212). In an embodiment where offline client device 116 is connected to server computer 104, via network 102, through a temporary connection to online client device 112, ads offload engine 108A downloads the selected ads to offline client device 116 by passing the ads through network 102 to online client device 112 which transmits the selected ads to offline client device 116. In an embodiment where offline client device 116 is temporarily connected directly to server computer 104, via network 102, ads offload engine 108A downloads the selected ads directly to offline client device 116.

Ads offload engine 108A queries the offline client device for tracking data (step 214). While the connection to offline client device 116 is maintained, ads offload engine 108A queries offline client device 116 for the presence of ad tracking data in database 118. Ad tracking data includes information regarding the rendering of one or more ads on offline client device 116. Ad tracking data is described in further detail with respect to FIG. 3.

Ads offload engine 108A determines whether tracking data is available (decision block 216). Responsive to querying offline client device 116 for the presence of ad tracking data in database 118, ads offload engine 108A determines whether ad tracking data is available. If ads offload engine 108A determines tracking data is not available (“no” branch, decision block 216), then ads offload engine 108A completes execution and ends.

If ads offload engine 108A determines tracking data is available (“yes” branch, decision block 216), then ads offload engine 108A retrieves tracking data (step 218). While the connection to offline client device 116 is maintained, ads offload engine 108A retrieves the ad tracking data from database 118 in offline client device 116 and stores the retrieved ad tracking data in database 110. In one embodiment, ads offload engine 108B uploads the tracking data stored in database 118 to a location from which ads offload engine 108A can retrieve the tracking data. For example, ads offload engine 108B may upload tracking data to online client device 112, or to database 110 on server computer 104, or to a cloud repository within distributed data processing environment 100 (not shown). In a further embodiment, offline client device 116 may be connected continuously, or for a considerable amount of time, to an online client device, such as online client device 112, and ads offload engine 108A downloads ads and uploads tracking data on an occasional basis. In one embodiment, based on the retrieved tracking data, ads offload engine 108A notifies the user of additional information available for the rendered ad. For example, ads offload engine 108B may send an email to the user that lists the ads that ads offload engine 108B rendered in the past week. The email may include interactive links to advertisers' websites. In another example, ads offload engine 108B may provide a website that the user can visit to find additional information regarding rendered ads. As the user interacts with the additional information, ads provider 106 can calculate additional statistics, such as conversion rate and CTR.

Ads offload engine 108A transmits data to provider (step 220). Ads offload engine 108A transmits the received ad tracking data to ads provider 106. The ads tracking data enables ads provider 106 to advise and negotiate with the one or more advertisers whose ads were rendered by ads offload engine 108A by providing information regarding the ads, such as the date or time an ad is displayed, frequency of display, etc. In addition, the ad tracking data enables a calculation of the user's accumulated ads credits or points by either ads offload engine 108A or ads provider 106.

In an embodiment, a user of online client device 112 runs web browser/app 114 on which ads provider 106 is about to display an ad. Prior to displaying the ad, ads provider 106 queries ads offload engine 108A for the user's available ads credits. Based on device preferences for online client device 112, ads provider 106 determines whether the user has accumulated sufficient ads credits for online client device 112. If ads provider 106 determines that the user has accumulated sufficient ads credits to qualify the device for reduced ad frequency, then ads provider 106 does not display an ad.

FIG. 3 is a flowchart depicting operational steps of the client side of ads offload engine 108B, on offline client device 116 within distributed data processing environment 100 of FIG. 1, for rendering and tracking advertisements on an offline computing device, in accordance with an embodiment of the present invention.

Ads offload engine 108B receives a request for an ad (step 302). In one embodiment, ads offload engine 108B receives a request for one or more ads by detecting appropriate circumstances, based on previously defined device and ad preferences. For example, the user of offline client device 116 listens to a podcast about new technology, and has specified that ads may be inserted every ten minutes during a podcast. At the same time, ads offload engine 108B detects an ad for a new smart phone in database 118, and determines that, based on device and ad preferences, the smart phone ad is suitable to insert during the podcast. In another embodiment, ads offload engine 108B receives a request for an ad directly from a user. For example, the user has a moment of free time, and, motivated to receive ad credits, requests an ad from ads offload engine 108B.

Ads offload engine 108B renders an ad (step 304). Based on device and ad preferences, ads offload engine 108B renders an ad on offline client device 116. For example, if offline client device 116 is an electronic picture frame, ads offload engine 108B renders a still video, i.e., picture, ad for the user to view on the screen of the electronic picture frame. In another example, if offline client device 116 is a GPS device in a car, ads offload engine 108B renders an audio ad so that the user does not have to look at a screen to receive the ad.

Ads offload engine 108B tracks the rendering (step 306). Ads offload engine 108B tracks the rendering of the ad in order to assist the user in accumulating credits or points toward incentives such as reducing the frequency of ads received on the user's one or more online client devices. In addition, ads offload engine 108B tracks a plurality of data associated with the rendering of the ad in order to provide valuable information to ads provider 106 and, ultimately, to the advertiser. For example, ads offload engine 108B may track the date and time the ad is rendered, as well as the frequency a particular ad is rendered. In another example, ads offload engine 108B may track the device on which the ad is rendered if the user has registered more than one offline client device. In a further example, if the offline client device includes GPS, ads offload engine 108B may track the location of the device at the time the ad is rendered. Ad tracking data also enables ads provider 106 to determine the cost of the ads based on information such as the frequency ads offload engine 108B displays the ad. In one embodiment, ads offload engine 108B may track a user's interaction with an ad. For example, if offline client device 116 includes a touch screen, ads offload engine 108B may determine whether the user tapped on an interactive link within the displayed ad. In another example, if offline client device 116 includes eye tracking technology, ads offload engine 108B may determine the duration that the user viewed an ad. Ads offload engine 108B stores the ad tracking data in database 118.

Ads offload engine 108B determines whether another ad is requested (decision block 308). As described with respect to step 302, ads offload engine 108B determines whether a request for another ad is received. Ads offload engine 108B may receive a request for an additional ad immediately after rendering an ad or over a period of time after rendering an ad. If ads offload engine 108B determines another ad is requested (“yes” branch, decision block 308), then ads offload engine 108B returns to step 302.

If ads offload engine 108B determines another ad is not requested (“no” branch, decision block 308), then ads offload engine 108B completes execution and ends.

FIG. 4 depicts a block diagram of components of server computer 104 or offline client device 116 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 104 and offline client device 116 can each include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., ads provider 106, ads offload engine 108A, and database 110 are stored in persistent storage 408 for execution and/or access by one or more of the respective processor(s) 404 of server computer 104 via cache 414. Program instructions and data used to practice embodiments of the present invention, e.g., ads offload engine 108B and database 118 are stored in persistent storage 408 for execution and/or access by one or more of the respective processor(s) 404 of offline client device 116 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of online client device 112. In these examples, communications unit 410 includes one or more network interface cards. Communications unit 410 may provide communications through the use of either or both physical and wireless communications links. Ads provider 106, ads offload engine 108A, and database 110 may be downloaded to persistent storage 408 of server computer 104 through communications unit 410. Ads offload engine 108B and database 118 may be downloaded to persistent storage 408 of offline client device 116 through communications unit 410.

I/O interface(s) 412 allows for input and output of data with other devices that may be connected to server computer 104 or offline client device 116. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., ads provider 106, ads offload engine 108A, and database 110 on server computer 104, can be stored on such portable computer readable storage media and can be loaded onto persistent storage 408 via I/O interface(s) 412. Software and data used to practice embodiments of the present invention, e.g., ads offload engine 108B and database 118 on offline client device 116, can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for tracking an offline advertisement, the method comprising:
downloading, by one or more computer processors, one or more advertisements from one or more advertisement providers to a first online computing device;
determining, by the one or more computer processors, whether a local communication connection exists between the first online computing device and at least one offline computing device;
responsive to determining that the local communication connection exists between the first online computing device and at least one offline computing device, selecting, by the one or more computer processors, based, at least in part, on one or more attributes of the at least one offline computing device, one or more advertisements to download from the first online computing device to the at least one offline computing device;
downloading, by the one or more computer processors, one or more selected advertisements to the at least one offline computing device;
determining, by the one or more computer processors, whether advertisement tracking data exists on the at least one offline computing device; and
responsive to determining advertisement tracking data exists on the at least one offline computing device, retrieving, by the one or more computer processors, advertisement tracking data from the at least one offline computing device.

2. The method of claim 1, further comprising, responsive to retrieving advertisement tracking data from the at least one offline computing device, transmitting, by the one or more computer processors, the advertisement tracking data to the one or more advertisement providers.

3. The method of claim 1, wherein retrieving advertisement tracking data further comprises determining, by the one or more computer processors, whether a local communication connection exists between a first offline computing device and the first online computing device.

4. The method of claim 1, wherein the advertisement tracking data includes data associated with one or more rendered advertisements on a first offline computing device.

5. The method of claim 1, wherein determining whether advertisement tracking data exists on the at least one offline computing device further comprises:
determining, by the one or more computer processors, whether a local communication connection exists between a first offline computing device and the first online computing device;
responsive to determining a local communication connection exists between the first offline computing device and the first online computing device, determining, by the one or more computer processors, whether a request is received for one or more downloaded advertisements on the first offline computing device; and
determining, by the one or more computer processors, whether one or more downloaded advertisements were rendered on the first offline computing device.

6. The method of claim 1, wherein selecting, based, at least in part, on one or more attributes of the at least one offline computing device, one or more advertisements to download from the first online computing device to the at least one offline computing device further comprises converting, by the one or more computer processors, a format of one or more of the one or more advertisements to a format compatible with the one or more attributes of the at least one offline computing device.

7. The method of claim 1, wherein attributes of the at least one offline computing device include at least one of: a capability to display still pictures, a capability to display video, a resolution capability for still pictures, a resolution capability for video, a capability to play audio, and a resolution capability to play audio.

8. A computer program product for tracking an offline advertisement, the computer program product comprising:
one or more computer readable storage device and program instructions stored on the one or more computer readable storage device, the program instructions comprising:
program instructions to download one or more advertisements from one or more advertisement providers to a first online computing device;
program instructions to determine whether a local communication connection exists between the first online computing device and at least one offline computing device;
responsive to determining that the local communication connection exists between the first online computing device and at least one offline computing device, program instructions to select, based, at least in part, on one or more attributes of the at least one offline computing device, one or more advertisements to download from the first online computing device to the at least one offline computing device;
program instructions to download one or more selected advertisements to the at least one offline computing device;
program instructions to determine whether advertisement tracking data exists on the at least one offline computing device; and
responsive to determining advertisement tracking data exists on the at least one offline computing device, program instructions to retrieve advertisement tracking data from the at least one offline computing device.

9. The computer program product of claim 8, further comprising, responsive to retrieving advertisement tracking data from the at least one offline computing device, program instructions to transmit the advertisement tracking data to the one or more advertisement providers.

10. The computer program product of claim 8, wherein retrieving advertisement tracking data further comprises program instructions to determine whether a local communication connection exists between a first offline computing device and the first online computing device.

11. The computer program product of claim 8, wherein the advertisement tracking data includes data associated with one or more rendered advertisements on a first offline computing device.

12. The computer program product of claim 8, wherein program instructions to determine whether advertisement tracking data exists on the at least one offline computing device further comprises:
program instructions to determine whether a local communication connection exists between a first offline computing device and the first online computing device;
responsive to determining a local communication connection exists between the first offline computing device and the first online computing device, program instructions to determine whether a request is received for one or more downloaded advertisements on the first offline computing device; and
program instructions to determine whether one or more downloaded advertisements were rendered on the first offline computing device.

13. The computer program product of claim 8, wherein program instructions to select, based, at least in part, on one or more attributes of the at least one offline computing device, one or more advertisements to download from the first online computing device to the at least one offline computing device further comprises program instructions to convert a format of one or more of the one or more advertisements to a format compatible with the one or more attributes of the at least one offline computing device.

14. The computer program product of claim 8, wherein attributes of the at least one offline computing device include at least one of: a capability to display still pictures, a capability to display video, a resolution capability for still pictures, a resolution capability for video, a capability to play audio, and a resolution capability to play audio.

15. A computer system for tracking an offline advertisement, the computer system comprising:
one or more computer processors;
one or more computer readable storage device;
program instructions stored on the one or more computer readable storage device for execution by at least one of the one or more computer processors, the program instructions comprising:
program instructions to download one or more advertisements from one or more advertisement providers to a first online computing device;
program instructions to determine whether a local communication connection exists between the first online computing device and at least one offline computing device;
responsive to determining that the local communication connection exists between the first online computing device and at least one offline computing device, program instructions to select, based, at least in part, on one or more attributes of the at least one offline computing device, one or more advertisements to download from the first online computing device to the at least one offline computing device;
program instructions to download one or more selected advertisements to the at least one offline computing device;
program instructions to determine whether advertisement tracking data exists on the at least one offline computing device; and
responsive to determining advertisement tracking data exists on the at least one offline computing device, program instructions to retrieve advertisement tracking data from the at least one offline computing device.

16. The computer system of claim 15, further comprising, responsive to retrieving advertisement tracking data from the at least one offline computing device, program instructions to transmit the advertisement tracking data to the one or more advertisement providers.

17. The computer system of claim 15, wherein retrieving advertisement tracking data further comprises program instructions to determine whether a local communication connection exists between a first offline computing device and the first online computing device.

18. The computer system of claim 15, wherein the advertisement tracking data includes data associated with one or more rendered advertisements on a first offline computing device.

19. The computer system of claim 15, wherein program instructions to determine whether advertisement tracking data exists on the at least one offline computing device further comprises:
program instructions to determine whether a local communication connection exists between a first offline computing device and the first online computing device;
responsive to determining a local communication connection exists between the first offline computing device and the first online computing device, program instructions to determine whether a request is received for one or more downloaded advertisements on the first offline computing device; and
program instructions to determine whether one or more downloaded advertisements were rendered on the first offline computing device.

20. The computer system of claim 15, wherein program instructions to select, based, at least in part, on one or more attributes of the at least one offline computing device, one or more advertisements to download from the first online computing device to the at least one offline computing device further comprises program instructions to convert a format of one or more of the one or more advertisements to a format compatible with the one or more attributes of the at least one offline computing device.
